(19) United States
(12) Patent Application Publication
(10) Pub. No.: US 2026/0264981 A1
(43) Pub. Date: Sep. 10, 2026

(54) AUTOMATIC CLOSING DIAPER PAIL METHOD AND SYSTEM

(71) Applicant: Munchkin, Inc., Van Nuys, CA (US)

(72) Inventors: Kevin Douglas JOHNSON, Tarzana, CA (US); Mau Chun YIP, Hong Kong (HK)

(73) Assignee: Munchkin, Inc., Van Nuys, CA (US)

(21) Appl. No.: 19/556,830

(22) Filed: Mar. 4, 2026

Related U.S. Application Data
(60) Provisional application No. 63/766,928, filed on Mar. 4, 2025.

(51) Int. Cl. B65F 1/16; B65F 1/06

(52) U.S. Cl. CPC B65F 1/1638; B65F 1/06; B65F 1/1646; B65F 2001/1676; B65F 2210/1675; B65F 2210/168; B65F 2240/132

(57) ABSTRACT

An automatic diaper pail can include a container body, a base attached to a lower end of the body, a lid assembly pivotably attached to the container body via a hinge, wherein the lid assembly includes a lid and a sensor adapted to detect a presence or action of a user, and a sleeve rotating mechanism disposed within the container body, the sleeve rotating mechanism including a sleeve and a motor adapted to rotate the sleeve, wherein the sleeve is adapted to transition between an open position and a cinched closed position.

### CROSS-REFERENCE TO RELATED APPLICATIONS

This patent applications claimed the benefit of and priority to U.S. Provisional Patent Application No. 63/766,928, filed on Mar. 4, 2025, entitled “AUTOMATIC CLOSING DIAPER PAIL METHOD AND SYSTEM,” which is expressly incorporated by reference herein in its entirety.

### TECHNICAL FIELD

The subject disclosure relates generally to a diaper pail. More particularly, the present disclosure relates to an automatic opening/closing diaper pail method and system.

### BACKGROUND

There are numerous types of diaper pails on the market. These diaper pails may include lids and doors to prevent odors from escaping the diaper pail. However, when the diaper pail is in use, there are often various steps required to place dirty diapers into the diaper pail. These steps can take time, during which odors can escape the diaper pail.

Thus, there is a need for a smart diaper pail operable to automatically open and close to prevent long durations for odors to escape the diaper pail.

### SUMMARY

The present subject disclosure presents a simplified summary of the subject disclosure in order to provide a basic understanding of some aspects thereof. This summary is not an extensive overview of the various embodiments of the subject disclosure. It is intended to neither identify key or critical elements of the subject disclosure nor delineate any scope thereof. The sole purpose of the subject summary is to present some concepts in a simplified form as a prelude to the more detailed description that is presented hereinafter.

To the accomplishment of the foregoing and related ends, the subject disclosure, then, comprises the features hereinafter fully described. The following description and the annexed drawings set forth in detail certain illustrative aspects of one or more embodiments of the disclosure. However, these aspects are indicative of but a few of the various ways in which the principles of the subject disclosure may be employed. Other aspects, advantages and novel features of the subject disclosure will become apparent from the following detailed description of various example embodiments of the subject disclosure when considered in conjunction with the drawings.

The present subject disclosure describes an automatic diaper pail method and system.

In one exemplary embodiment, an automatic diaper pail includes a container body, a base attached to a lower end of the body, a lid assembly pivotably attached to the container body via a hinge, wherein the lid assembly includes a lid and a sensor adapted to detect a presence or action of a user, and a sleeve rotating mechanism disposed within the container body, the sleeve rotating mechanism including a sleeve and a motor adapted to rotate the sleeve, wherein the sleeve is adapted to transition between an open position and a cinched closed position.

In one exemplary embodiment, a diaper pail includes a container body, a base attached to a lower end of the body a lid assembly pivotably attached to the container body via a hinge, wherein the lid assembly includes a top lid, a lower lid, and a sensor adapted to detect a presence or action of a user, and a sleeve rotating mechanism disposed within the container body, the sleeve rotating mechanism including a sleeve and a motor adapted to rotate an upper end of the sleeve relative to a lower end of the sleeve, and wherein the sleeve is adapted to transition between an open position and a cinched closed position.

In one exemplary embodiment, a method for operating an automatic diaper pail includes determining, by a controller, a presence and/or an action of a user, sending, by the controller, a command to a lid assembly hinge mechanism of the automatic diaper pail to cause opening of a top lid of a lid assembly of the automatic diaper pail, and sending, by the controller, a command to a rotating mechanism of the automatic diaper pail to cause rotation of a sleeve, thereby causing the sleeve to untwist and unblock a central aperture of the sleeve.

### BRIEF DESCRIPTION OF THE DRAWINGS

Various exemplary embodiments of this disclosure will be described in detail, wherein like reference numerals refer to identical or similar components or steps. The accompanying drawings, which are incorporated in and constitute a part of this specification, illustrate embodiments of the subject disclosure and technical data supporting those embodiments, and together with the written description, serve to explain certain principles of the subject disclosure. With reference to the following figures, wherein:

FIG. 1 is a perspective view of an automatic diaper pail, in accordance with some aspects of the present disclosure.

FIG. 2 is a top view of the automatic diaper pail in a closed configuration, in accordance with some aspects of the present disclosure.

FIG. 3 is a partial cross-section view through section A-A in FIG. 2, in accordance with some aspects of the present disclosure.

FIG. 4 is a partial cross-section view through section B-B in FIG. 2, in accordance with some aspects of the present disclosure.

FIG. 5 is a partial cross-section view through section B-B in FIG. 2 , in accordance with some aspects of the present disclosure.

FIG. 6 is a close up view of a rotating mechanism illustrated in FIG. 5, in accordance with some aspects of the present disclosure.

FIG. 7 is a top view of the automatic diaper pail in an open configuration, in accordance with some aspects of the present disclosure.

FIG. 8 is a partial cross-section view through section C-C in FIG. 8, in accordance with some aspects of the present disclosure.

FIG. 9 illustrates a top view of the automatic diaper pail in an intermediate configuration, in accordance with some aspects of the present disclosure.

FIG. 10 is a partial cross-section view through section D-D in FIG. 9, in accordance with some aspects of the present disclosure.

FIG. 11 illustrates a top view of the automatic diaper pail in a closed configuration, in accordance with some aspects of the present disclosure.

FIG. 12 is a perspective view of the automatic diaper pail in an open configuration, in accordance with some aspects of the present disclosure.

FIG. 13 is a perspective view of the automatic diaper pail in an open configuration with a first bag assembly therein, in accordance with some aspects of the present disclosure.

FIG. 14 is a perspective view of the automatic diaper pail in an open configuration with a second bag assembly therein, in accordance with some aspects of the present disclosure.

FIG. 15 is a rear view of the automatic diaper pail, in accordance with some aspects of the present disclosure.

FIG. 16 illustrates an example method or routine of opening and closing a diaper pail, in accordance with some aspects of the present disclosure.

FIG. 17 illustrates an example method or routine of opening and closing a diaper pail, in accordance with some aspects of the present disclosure.

### DETAILED DESCRIPTION

The following detailed description references specific embodiments of the subject disclosure and accompanying figures, including the respective best modes for carrying out each embodiment. It shall be understood that these illustrations are by way of example and not by way of limitation. Particular embodiments of an automatic closing diaper pail method and system will now be described in greater detail with reference to the figures.

The present subject disclosure describes an automatic diaper pail method and system. In one exemplary embodiment, the automatic diaper pail of the present subject disclosure includes a housing having an upper end and a lower end, a base attached at the lower end, a lid pivotally attached to a lid motor at a hinge to the upper end, the lid having a motion sensor adapted to open the lid when an object is detected contemporaneously close to the motion sensor, and a sleeve connected at an upper end to a circular gear adapted to rotate by a sleeve motor, a lower end of the sleeve fixedly connected to prevent rotation, wherein the sleeve is adapted to move from an open position to a cinched closed position, a bag support structure positioned within the housing having an opening adapted to receive two different types of flexible bag assemblies, the bag support structure having a first stationary support member with a first support surface onto which a first bag assembly is secured, and a second stationary support member having a second support surface that extends horizontally below the first support surface that is adapted to receive a cassette of a second bag assembly.

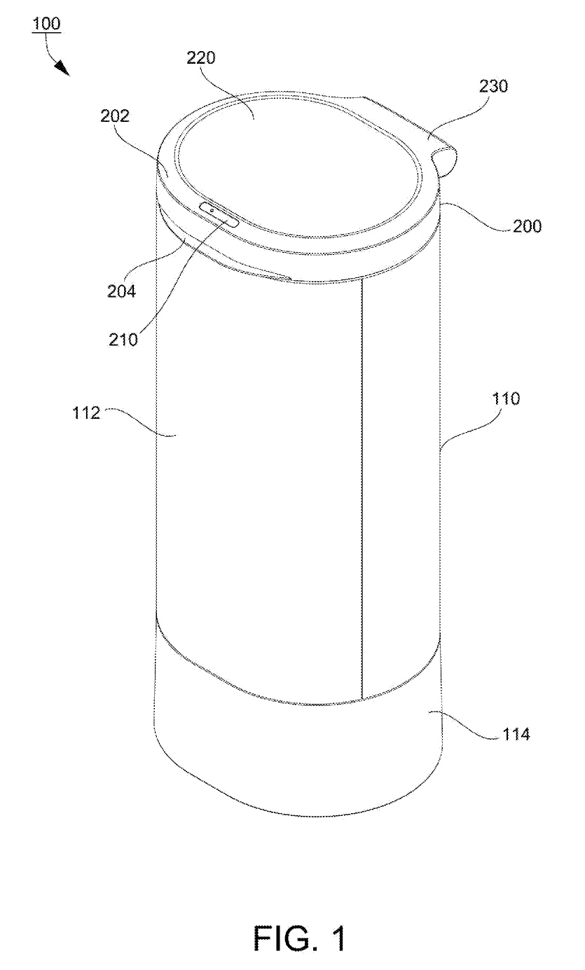

FIG. 1 is a perspective view of an automatic diaper pail 100, in accordance with some aspects of the present disclosure. The diaper pail 100 has a container body 110, a door 112, a base 114, and a lid assembly 200. The diaper pail 100 can include a sensor 210 adapted to detect when an object, such as a user’s hand, is waived contemporaneously near the sensor to open the lid assembly 200 so that a dirty diaper may be discarded.

Container body 110 encloses an interior compartment that is hollow. Container body 110 includes a door 112 operable to open and close to provide and/or prevent access to the interior compartment of container body 110. As shown in FIG. 1, the interior compartment may be obscured from view when door 112 is in a closed position.

A lid assembly 200 can be pivotably attached to a top end of container body 110 via a lid assembly hinge mechanism 230. Lid 200 can include a lid cover 202 that can receive and secure a top lid 220 and enclose and secure a lower lid 240. Lid 200 can include a tab 204 to open lid assembly 200 from container body 110 by pivoting lid assembly 200 about lid assembly hinge mechanism 230. Lid assembly hinge mechanism is operable to pivot lid assembly 200 between an open position and a closed position in relation to container body 110.

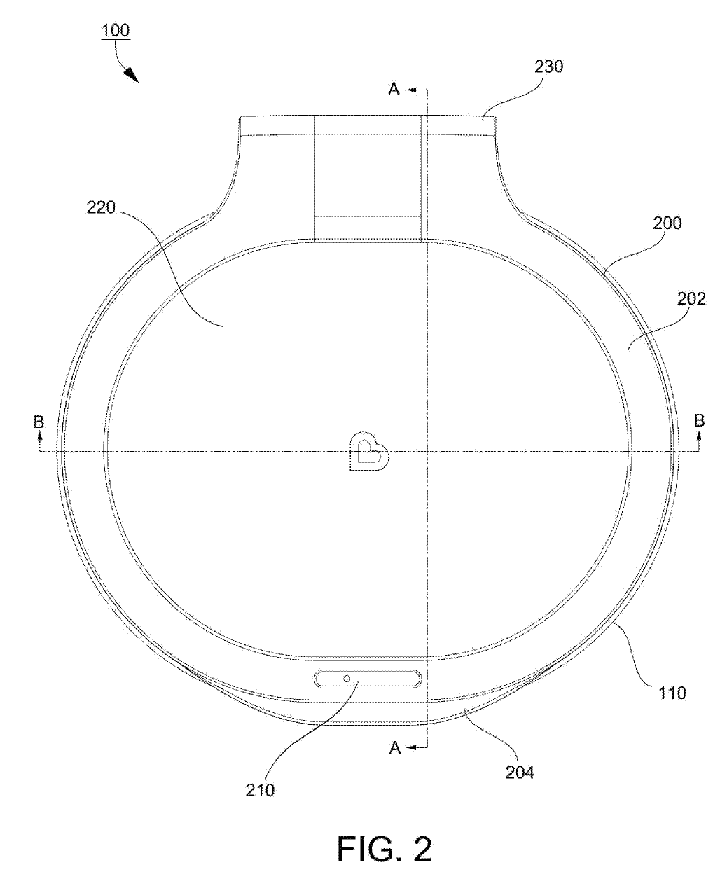

FIG. 2 is a top view of the automatic diaper pail 100. An outer lid or top lid 220 may be attached to an upper portion of lid assembly 200. As will be further discussed below, top lid 220 can prevent access to the interior compartment of container body 110 when top lid 220 and lid assembly 200 are closed.

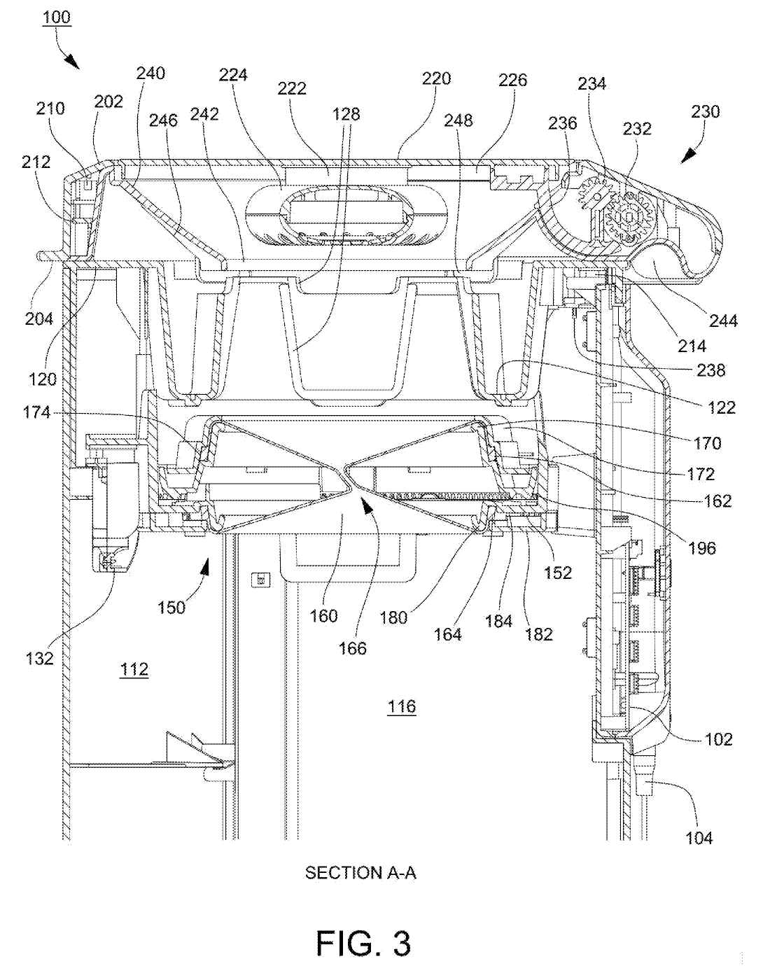

Sensor 210 may be disposed on an outer surface of lid assembly 200. For example, FIG. 2 illustrates sensor 210 on a top surface of lid assembly 200. As illustrated, sensor 210 can detect an object and/or movement of an object thereabove and communicate (e.g., with sensor printed circuit board (PCB) 212 labeled in FIG. 3 and discussed in further detail below) with other modules to coordinate and/or otherwise actuate movement of top lid 220. For example, sensor 210 may be a motion sensor configured to detect motion, such as a user waving their hand above the automatic diaper pail 100 and cause top lid 220 to open. In some embodiments, sensor 210 may communicate (e.g., via sensor PCB 212) with lid assembly hinge mechanism 230 to pivot top lid 220 from a closed position to an open position, thereby allowing access to the inner compartment of container body 110. In some embodiments, sensor 210 may be an infrared sensor, ultrasonic sensor, weight sensor or other sensor configured to capture the presence and/or an action of a user.

FIG. 3 is a partial cross-section view through section A-A in FIG. 2 of the automatic diaper pail 100. FIG. 3 illustrates the automatic diaper pail 100 in a closed position.

Lid assembly 200 can include a top lid 220 and a lower lid 240. Top lid 220 and lower lid 240 may be separately pivotable from one another and/or from container body 110 about lid assembly hinge mechanism 230. This dual-lid configuration permits separation of functions. For example, top lid 220 may be actuated automatically in response to sensor input as lower lid 240 remains stationary to dispose of waste. Lower lid 240 may be separately actuated to access a compartment for a bag assembly (e.g., a single-use bag and/or a refill cassette) stored therein. For example, a user can choose to only open top lid 220 to deposit waste, or open both top lid 220 and lower lid 240 in order to replace a bag assembly.

FIG. 3 illustrates top lid 220 in a closed position, such that top lid 220 is closed and secured into and/or on lower lid 240 of lid assembly 200. FIG. 3 further illustrates lower lid 240 of lid assembly 200 in a closed position and abutting against container body 110. In the closed position, top lid 220 and lid assembly 200 prevent access to inner compartment 116 of container body 110.

Lid assembly hinge mechanism 230 can include a lid motor 232, a lid gear 234, a rigid lid extension 236, and a lid motor PCB 238. Lid motor 232 is operable to rotate lid gear 234 (e.g., via a drive gear). Lid gear 234 may be connected to a rigid lid extension 236 that is attached to top lid 220. When lid motor 232 rotates lid gear 234, lid gear 234 actuates rotation of top lid 220 via rigid lid extension 236. In some embodiments, lid motor 232 is controlled via lid motor PCB 238. For example, lid motor PCB 238 can receive communications and/or instructions (e.g., from sensor PCB 212 and/or other modules) and operate lid motor 232 to pivot top lid 220 between an open and a closed position.

Top lid 220 may also include an attachment structure 222 operable to receive and secure an attachment 224. In some embodiments, attachment 224 may be a puck shaped attachment. For example, attachment 224 may be an odor control device operable to absorb or otherwise reduce odors adjacent thereto. Attachment 224 may be positioned on top lid 220 to align above lower lid central opening 243 defined by lower lid aperture 242 and above sleeve control structure 150 to reduce odors from inner compartment 116.

Lower lid 240 is operable to cover container body 110. More specifically, lower lid 240 can be positioned to cover and rest on top of a bag support structure 120 of container body 110. Lower lid 240 may include bag securing protrusions 248 disposed along a lower surface of lower lid 240. Bag securing protrusions 248 may be positioned to press and secure a bag assembly against first support surface 122 and/or second support surface 124 of bag support structure 120.

Lower lid 240 may have a lower lid aperture 242 defining a central opening 243 to allow access to the inner compartment 116 of container body 110. Central opening 243 defined by lower lid aperture 242 may be aligned above a sleeve control structure 150 of container body 110. When top lid 220, lid assembly 200, and sleeve control structure 150 are in open configurations, a user may place an object (e.g., a dirty diaper) through the central opening 243 in the lower lid aperture 242 and through a central aperture or lumen 166 of sleeve control structure 150 into the inner compartment 116 of container body 110.

Lower lid 240 may also have a recess 250 operable to receive and secure top lid 220 therewithin when top lid 220 is in a closed position.

In some embodiments, lid assembly hinge mechanism 230 is operable to pivot top lid 220 between an open position and a closed position, such that lower lid 240 is accessible when the top lid 220 is in the open position and lower lid 240 is not accessible when the top lid 220 is in the closed position. In some embodiments, lower lid 240 may also have a button aperture to allow access to a door release button operable to unlock door 112. In some embodiments, a cutting tool 132 may be disposed within inner compartment 116 and protected by door 112 to assist users with cutting used bags within inner compartment 116.

In some embodiments, sensor 214 may be disposed within lid assembly 200. Sensor 214 may be, for example, an IR hall sensor operable to determine a position and/or movement of at least one component of lid assembly 200. The various sensors can provide commands so that the various lids will open and close at predetermined times to prevent any operational disruption while in use. Sensor 214 can be in communication with other electrical components, such as control PCB 152 (e.g., through a sensor PCB).

As will be discussed in further detail below, printed control boards (PCB) can also be utilized to control various aspects of the present disclosure. For example, a lid motor PCB 238 may be disposed within the automatic diaper pail 100. Lid motor PCB 238 is in communication with and configured to control lid motor 232. In some embodiments, lid motor PCB 238 is in communication with sensor PCB 212, control PCB 152, and other electrical components.

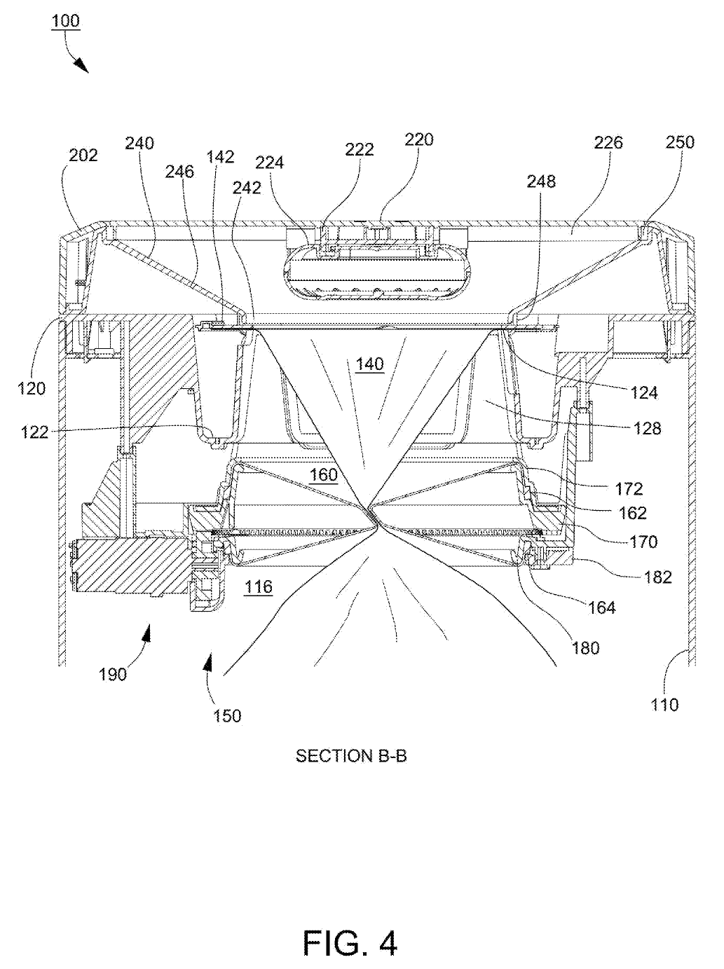

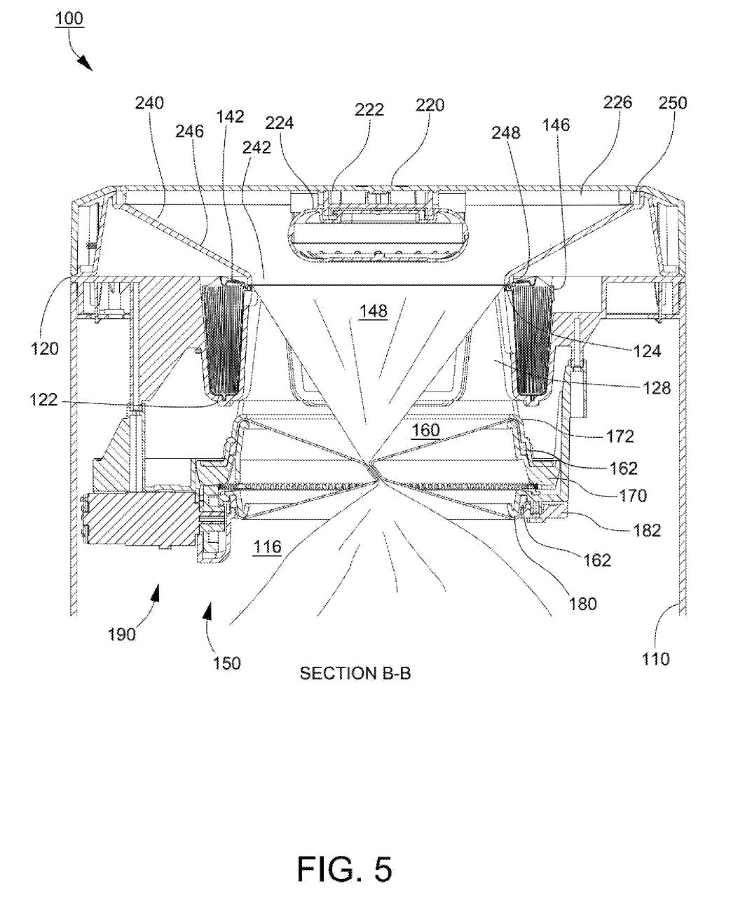

FIGS. 4 and 5 are partial cross-section views through section B-B in FIG. 2 of the automatic diaper pail 100. More specifically, FIG. 4 illustrates a single-use bag 140 disposed in automatic diaper pail 100. Container body 110 can include a bag support structure 120. Bag support structure 120 can include a first support surface 122 may be constructed to receive and secure at least a first bag assembly. For example, FIG. 4 illustrates first support surface 122 receiving and securing frame 142 of a single-use bag 140. Frame 142 of single-use bag 140 is depicted to be disposed between lower lid 240 of lid assembly 200 and first support surface 122 of container body 110. Bag securing protrusions 248 of lower lid 240 press down onto and against frame 142, thereby securing single-use bag 140 on to first support surface 122.

Bag support structure 120 can also include a second support surface 124 operable to receive and secure at least a second bag assembly. For example, FIG. 5 illustrates second support surface 124 receiving and securing a refill cassette 146 containing flexible tubing 148 in automatic diaper pail 100. Bag securing protrusions 248 of lower lid 240 press down onto and against refill cassette 146, thereby securing refill cassette 146 on to second support surface 124.

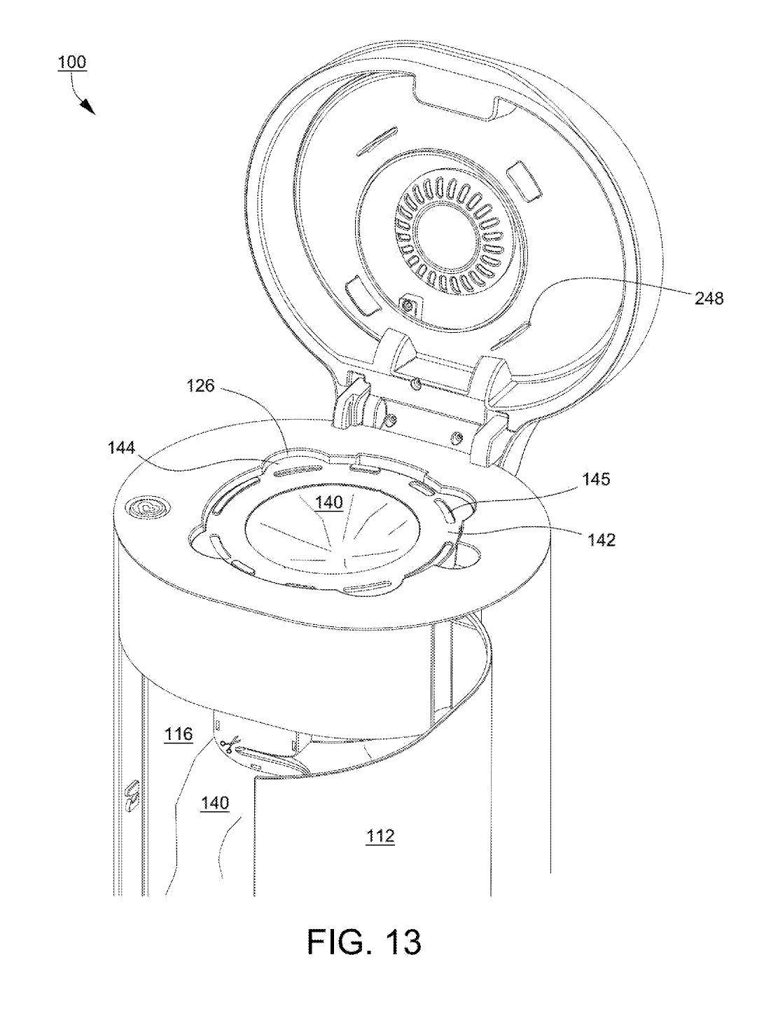

Bag support structure 120 can also include tab recesses 126 (e.g., as shown in FIGS. 13-15) and positioning bosses 128 to facilitate receiving, securing, and proper positioning of bag assemblies.

FIGS. 3-5 also illustrate sleeve control structure 150 disposed within container body 110. Sleeve control structure 150 can include a control PCB 152, a sleeve 160, a top retainer 170, a lower retainer 180, and a rotating mechanism 190.

Control PCB 152 can control twisting of sleeve 160. For example, control PCB 152 can be in communication with and send commands to a rotation mechanism 190.

Sleeve 160 is an odor control sleeve constructed of a flexible material. Sleeve 160 is disposed in container body 110 via top retainer 170 and lower retainer 180. Sleeve 160 is positioned to be generally tubular and define central aperture or a lumen 166 extending between an upper end 162 of sleeve 160 and a lower end 164 of sleeve 160. An intermediate portion of sleeve 160 between upper end 162 and lower end 164 can be twisted from an open position to a closed position, thereby closing lumen 166 and preventing odors from passing therethrough, or untwisting from a closed position to an open position, thereby allowing a user to place an object through lumen 166 defined by sleeve 160. Sleeve 160 may be positioned beneath lower lid aperture 242 such that lumen 166 is aligned with central opening 243.

In some embodiments, twisting of sleeve 160 can induce corresponding constriction of the disposable bag without the need for mechanical fastening of the bag to rotating mechanism 190. For example, sleeve 160 can be constructed of a material that can cause a bag at least partially disposed within lumen 166 to move with sleeve 160 (e.g., with friction) without rupturing the bag as sleeve 160 rotates. As sleeve 160 twists and untwists, the bag may be respectively sealed and unsealed to control access to the bag and control odors from waste disposed within the bag. In some embodiments, the transition between the open configuration and the cinched configuration can be achieved through twisting alone without lengthwise compression. The relative angular change between upper end 162 and lower end 164 generates a twist in sleeve 160 that narrows the passage through sleeve 160.

Top retainer 170 receives and secures upper end 162 of sleeve 160 in a recess 174 defined by top retainer 170 and an upper locking retainer 172. Top retainer 170 is in communication with a rotating mechanism 190 and configured to rotate with respect to lower retainer 180.

Lower retainer 180 receives and secures lower end 164 of sleeve 160 in a recess 184 defined by lower retainer 180 and a lower guard 182. Lower retainer 180 is attached to container body 110 and is configured to remain stationary within container body 110.

As top retainer 170 rotates, upper end 162 of sleeve 160 also rotates, while lower end 164 of sleeve 160 is held stationary by lower retainer 180. Consequently, an intermediate section of sleeve 160 twists (e.g., as shown in FIGS. 3-5 and 9-11).

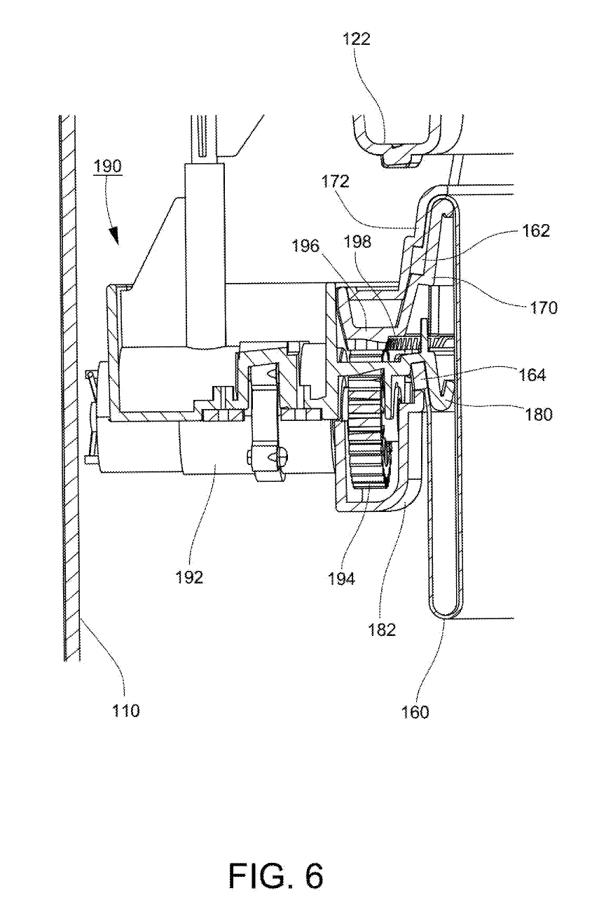

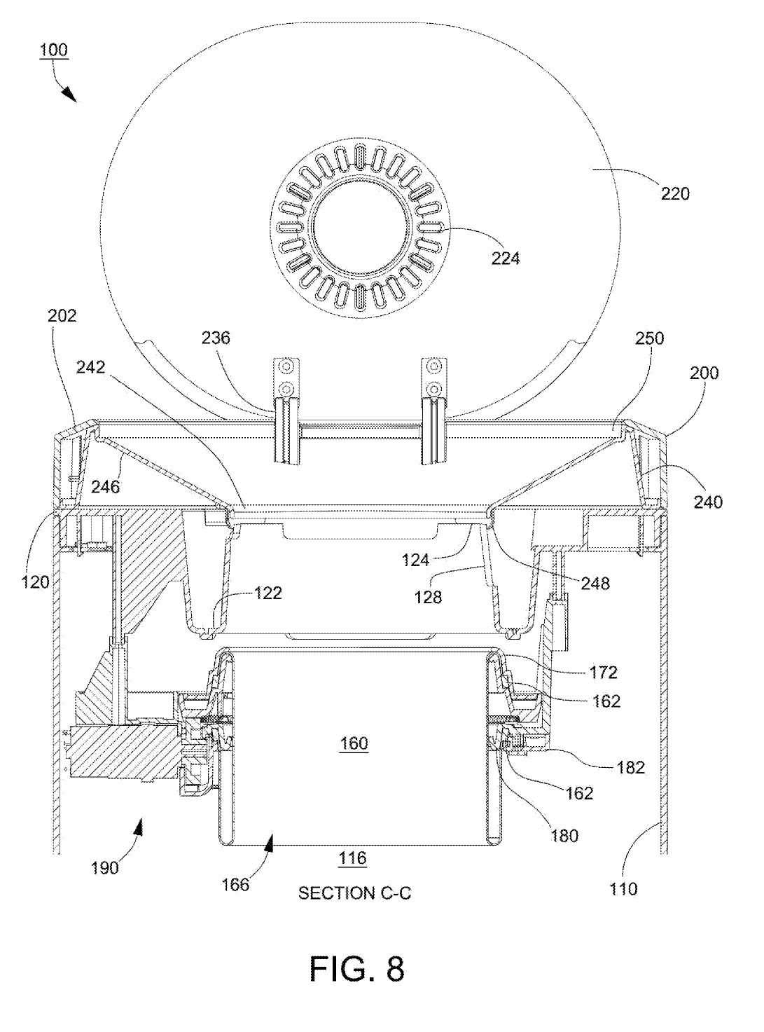

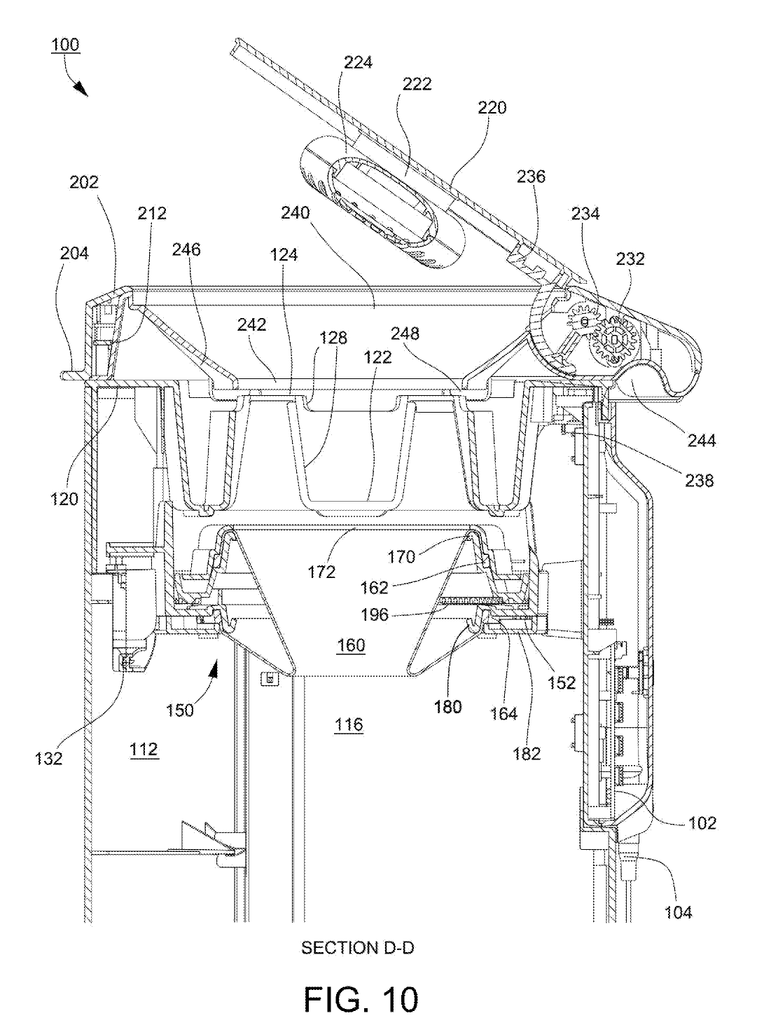

FIG. 6 is close-up view of rotating mechanism 190 as shown below in FIG. 8 and similarly shown in FIGS. 4 and 5. Rotating mechanism 190 can be disposed in container body 110. Rotating mechanism 190 may be connected to a closure tray, such as a circular gear 196, and adapted to rotate the closure tray forward and backward. Rotation mechanism 190 is operable to rotate at least a portion of sleeve 160. Rotation mechanism 190 can rotate sleeve 160 between a closed or cinched configuration (e.g., as shown in FIGS. 3-5) and an open configuration (e.g., as shown in FIG. 8). FIG. 10 illustrates an intermediate configuration between the closed or cinched configuration and the open configuration.

Rotation mechanism 190 can include a motor 192 that actuates rotation of a drive gear 194. Drive gear 194 may be in communication with a circular gear 196 (e.g., via gear teeth 198 of circular gear 196). In some embodiments, drive gear 194 may rotate about a first axis, while circular gear 196 rotates about a second axis orthogonal to the first axis.

Top retainer 170 may have or be attached to circular gear 196, such that top retainer 170 rotates with circular gear 196. Consequently, when motor 192 rotates drive gear 194, circular gear 196, top retainer 170, and upper end 162 of sleeve 160 also rotate. The rotation of upper end 162 of sleeve 160 in relation to lower retainer 180 and lower end 164 of sleeve 160 causes an intermediate portion of sleeve 160 to twist and/or untwist based on the direction of the rotation and the previous position of sleeve 160.

Although the above discussion shows and describes rotation of upper end 162, one of ordinary skill in the art would understand that the present disclosure also teaches configuring automatic diaper pail 100 and the components therein to rotate lower end 164 of sleeve 162. For example, top retainer 170 may be stationary and lower retainer 180 may rotate with circular gear 196 to cause rotation of lower retainer 180 and lower end 164, while keeping upper 162 stationary and thereby twisting and/or untwisting the intermediate portion of sleeve 160. Similarly, the present disclosure also teaches configuring automatic diaper pail 100 to rotate both top retainer 170 and lower retainer 180. For example, top retainer 170 may rotate in one direction (e.g., clockwise) and lower retainer 180 can rotate in a different direction (e.g., counterclockwise). As another example, top retainer 170 may rotate in one direction and lower retainer rotation 180 may rotate in the same direction at a different angular velocity, thereby still causing a twist or untwisting thereof in sleeve 160 through the difference between the rotational velocities.

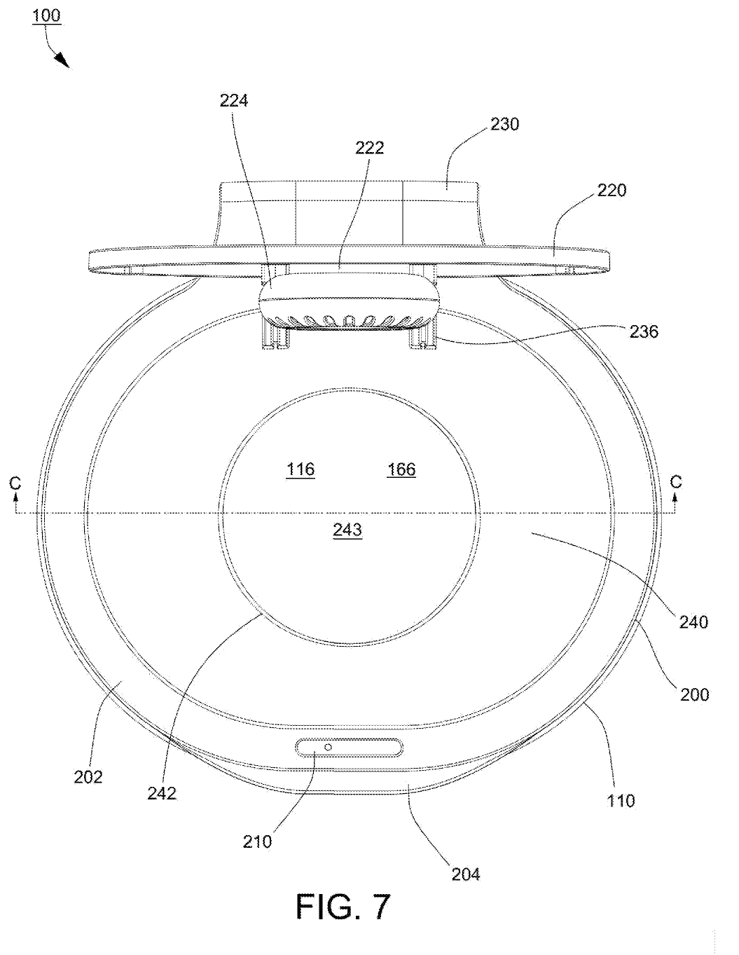

FIG. 7 illustrates a top view of automatic diaper pail 100 in an open configuration, such that top lid 220 is open and positioned away from lid cover 202. Top lid 220 may be pivoted to the open position using lid assembly hinge mechanism 230. For example, lid motor 232 can drive lid gear 234 and rotate top lid 220 from a closed position to an open position via rigid lid extension 236 and/or vice versa.

In the open position, top lid 220 is removed from lid cover 202 to allow access to lower lid 240, lower lid aperture 242, and central opening 243 defined by lower lid aperture 242. While top lid 220 is in this open position, sleeve 160 has been rotated and positioned such that sleeve 160 does not block central opening 243. Since sleeve 160 is retracted and not blocking central opening 243, a user can then place objects through central opening 243 into inner compartment 116.

In some embodiments, lid assembly hinge mechanism 230 can coordinate with sleeve control structure 150 and/or vice versa. For example, pivoting of top lid 220 can cause sleeve control structure 150 to untwist sleeve 160 when pivoting top lid 220 from a closed position to an open position, such that when top lid 220 is moved to the open position, sleeve 160 is substantially simultaneously untwisted to allow access through lumen 166 of sleeve 160 while top lid 220 permits access to central opening 243, thereby permitting a user to quickly place objects into inner compartment through central opening 243 and lumen 166 without additional steps. Similarly, pivoting top lid 220 closed can cause sleeve control structure 150 to twist sleeve 160 when top lid 220 is moved to the closed position, such that sleeve 160 is substantially simultaneously closed to capture and prevent odors from waste disposed in inner compartment 116 from escaping. It is further contemplated that lid assembly hinge mechanism 230 and sleeve control structure 150 can communicate and coordinate with other modules for controlling automatic diaper pail 100 including, but not limited to, sensor 210 (e.g., via sensor PCB 212), a step actuation function for opening and closing top lid 220, a remote control, communications from a wireless device, etc.

In some embodiments, automatic diaper pail 100 may have lid cover 202 positioned to encase lower lid 240. When top lid 220 is removed from lid cover 202, lid cover 202 may still be positioned to cover lower lid 240 to secure lower lid 240 and reduce gaps in automatic diaper pail 100, thereby further isolating odors within automatic diaper pail 100 and preventing the odors from spreading.

FIG. 8 is a partial cross-sectional view through section C-C in FIG. 7 of automatic diaper pail 100. FIG. 8 illustrates automatic diaper pail 100 in an open configuration, such that top lid 220 is in an open position, thereby allowing access to central opening 243 defined by inner lid aperture 242, central aperture or lumen 166, and inner compartment 116. Top lid 220 is pivoted to and held in the open position via rigid lid extension 236. In the open position, sleeve 160 is relaxed or untwisted, thereby allowing access therethrough. As discussed above, sleeve 160 may be untwisted using rotating mechanism 190 to rotate top end 162 of sleeve 160 in relation to lower end 164 of sleeve 160. As top end 162 is rotated from the closed position to the open position, bottom end 164 is rotationally stationary relative to top end 162 and container body 110, thereby untwisting sleeve 160 and unblocking central aperture 166.

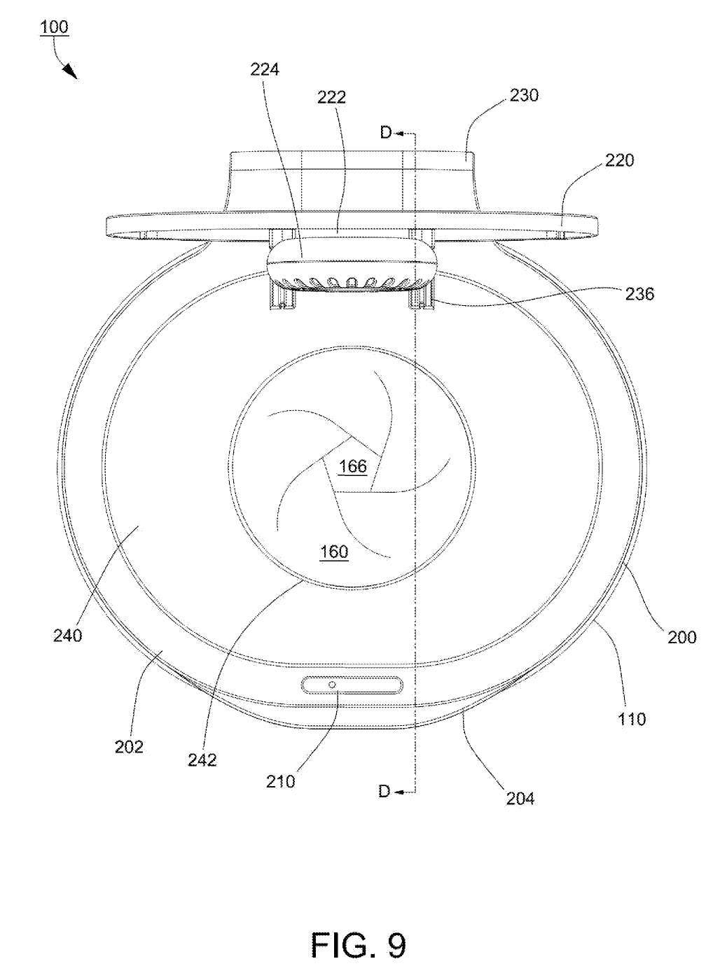

FIG. 9 is a top view of automatic diaper pail 100 in an intermediate configuration. The intermediate configuration may have top lid 220 in between an open position and a closed position. While FIG. 9 illustrates top lid 220 as upright relative to automatic diaper pail 100, it is to be understood that FIG. 9 is illustrated in this manner to prevent obscuring of sleeve 160 and central aperture 166 therethrough for discussion purposes. One of ordinary skill in the art would understand that top lid 220 may be positioned at an angle relative to automatic diaper pail 100 in the intermediate configuration, for example as illustrated in FIG. 10.

As shown in FIGS. 9 and 10, when automatic diaper pail 100 is in an intermediate configuration, such that top lid 220 is in between an open position and a closed position, sleeve 160 is partially cinched or twisted, thereby causing central aperture 166 to be partially constricted or obstructed. The intermediate position may be caused by opening top lid 220 from a closed position to an open position or by closing top lid 220 from an open position to a closed position. By opening top lid 220 from a closed position to an open position, sleeve 160 is untwisted and a previously obstructed central aperture 166 becomes accessible, thereby allowing a user to place an object therethrough. By closing top lid 220 from an open position to a closed position, sleeve 160 is twisted and the previously unobstructed central aperture 166 is blocked by the intermediate portion of sleeve 160, thereby preventing odors from escaping therethrough.

As discussed above, the opening and closing of top lid 220 can be actuated in response to various different situations. For example, sensor 210 can detect motion above lid assembly 200 and communicate (e.g., via sensor PCB 212) with lid assembly hinge mechanism 230 (e.g., via lid motor PCB 238) to cause lid assembly hinge mechanism 230 to open top lid 220 and/or with sleeve control structure 150 (e.g., via control PCB 152) to cause rotating mechanism 190 to untwist sleeve 160. In some embodiments, a centralized controller can be used to coordinate the action of the various different structures and PCBs of automatic diaper pail 100. For example, USB PCB 102 can be configured to receive communications from the various different PCBs and coordinate command across the PCBs and structures.

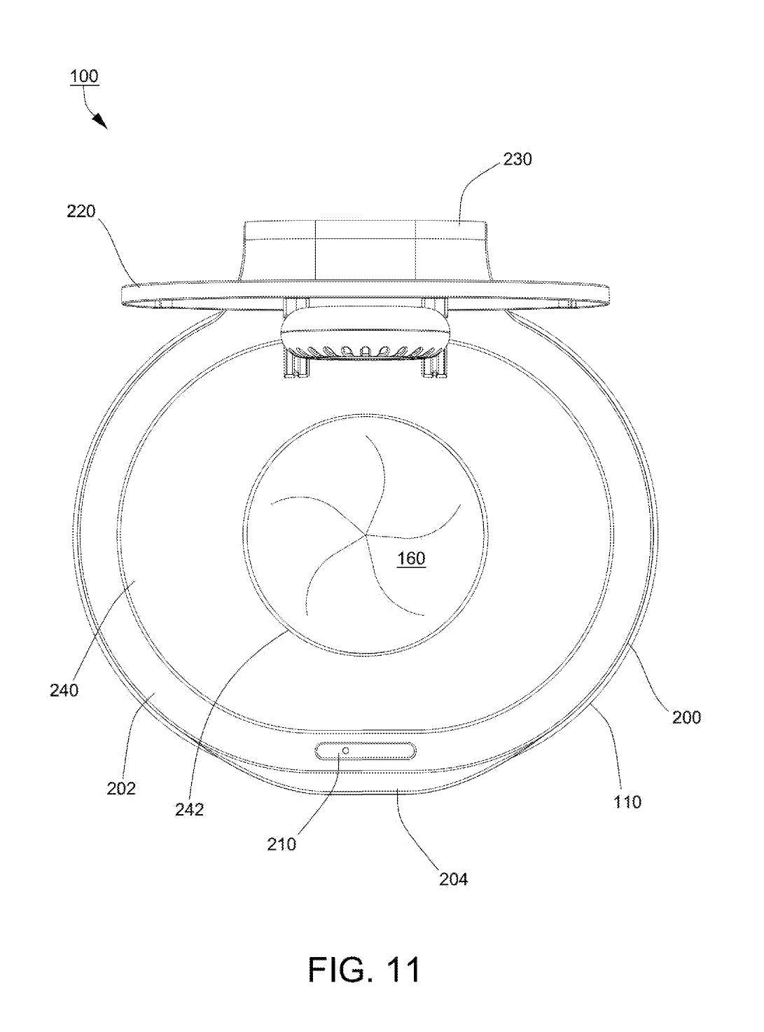

FIG. 11 is a top view of automatic diaper pail 100 in a closed configuration. While FIG. 11 illustrates top lid 220 as upright relative to automatic diaper pail, it is to be understood that FIG. 11 is illustrated in this manner to prevent obscuring of sleeve 160 for discussion purposes. One of ordinary skill in the art would understand that top lid 220 may be positioned against lid cover 202 and lower lid 240 in the closed configuration, for example as illustrated in FIGS. 1-5.

When top lid 220 is in the closed position, sleeve 160 may also be in a closed position. For example, when top lid 220 is in the closed position, sleeve 160 is twisted and the previously unobstructed central aperture 166 is blocked by the intermediate portion of sleeve 160 and odors are prevented from escaping therethrough. As discussed above, the twisting of sleeve 160 may be coordinated with the closing of top lid 220, such that closing top lid 220 can cause sleeve 160 to be twisted by sleeve control structure 150. For example, lid assembly hinge mechanism 230 may communicate (e.g., via lid motor PCB 238) with sleeve control structure 150 (e.g., via control PCB 152) to cause sleeve control structure to rotate sleeve 160 closed.

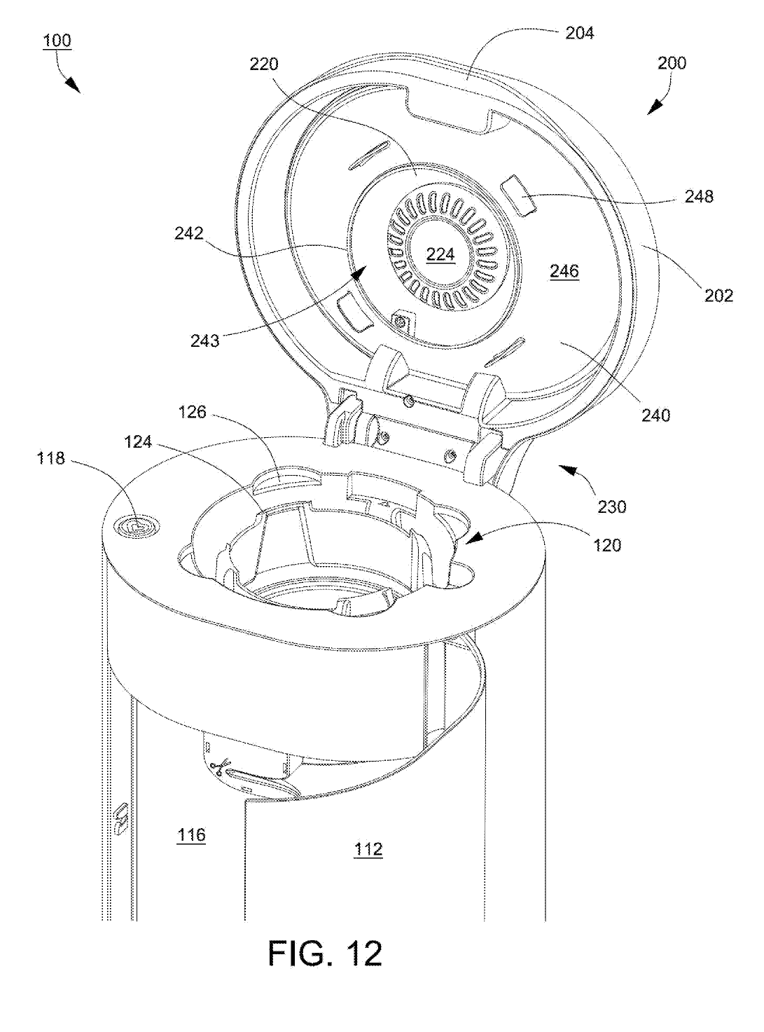

FIGS. 12-14 illustrate automatic diaper pail 100 in an open configuration, such that lid assembly 200 is open and pivoted away from the upper end of container body 110 and door 112 is open and permitting direct access to inner compartment 116.

FIG. 12 illustrates automatic diaper pail 100 in the open configuration without a bag assembly disposed therein. As shown, lid assembly 200 can be pivoted away from the upper end of container body 110 about an axis of the lid assembly hinge mechanism. In this view, top lid 220 is mostly obscured from view by lid cover 202 and lower lid 240 but is partially visible through central opening 243 of lower lid 240. Lower surface 246 of lower lid 240 can include bag securing protrusions 248 to abut against one or more bag assemblies and secure the one or more bag assemblies against at least one of first support surface 122 (obscured from view in FIGS. 12-14 but illustrated in FIGS. 3-6, 8, and 10) and/or second support surface 124 of bag support structure 120.

FIG. 13 illustrates a first bag assembly used with the automatic diaper pail 100. The first bag assembly is illustrated as a single-use bag 140 having a frame 142. As illustrated, bag support structure 120 may also include tab recesses 126 to receive and secure tabs 144 along frame 142 of single-use bag 140 (e.g., against first support structure 122 as illustrated in FIG. 4), thereby securing single-use bag 140 within automatic diaper pail 100. In some embodiments, the bag assembly may also have positioning recesses 145 that mate with bag securing protrusions 248 to ensure proper positioning of the bag assembly within automatic diaper pail 100 and reduce movement of the bag assembly when in use.

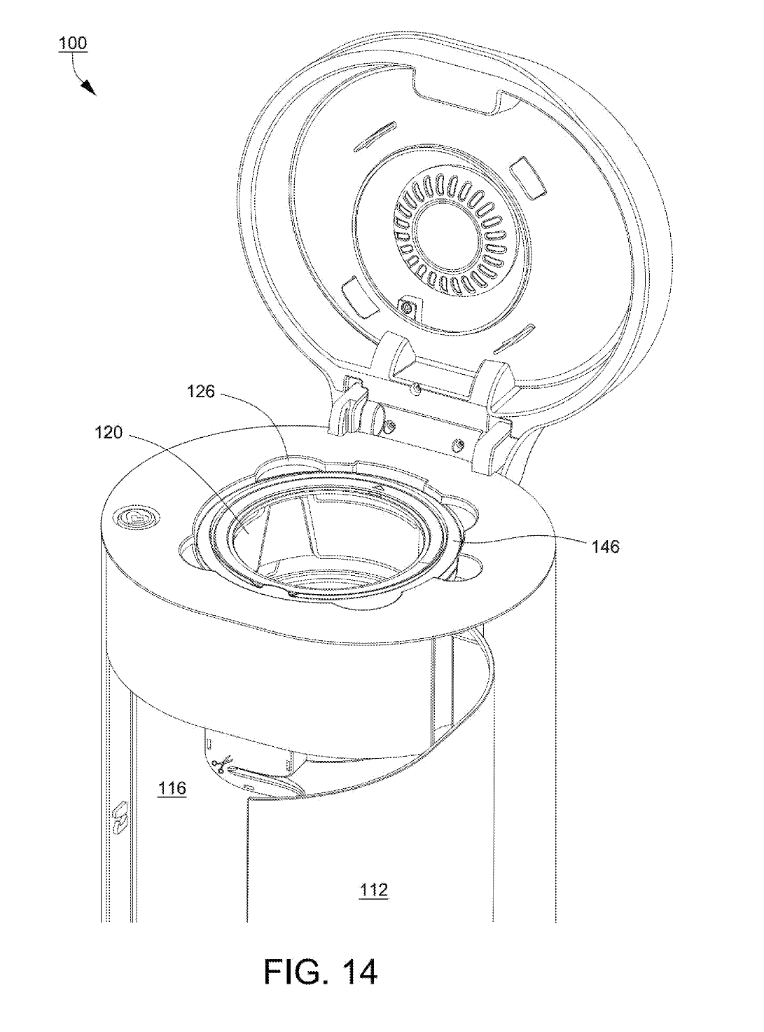

FIG. 14 illustrates a second bag assembly used with the automatic diaper pail 100. The second bag assembly is illustrated as a refill cassette 146 that can have a flexible tubing 148 disposed therewithin. As illustrated, bag support structure 120 can receive and secure refill cassette 146 (e.g., against second support structure 124 as illustrated in FIG. 5), thereby securing the bag assembly within automatic diaper pail 100. Since flexible tubing 148 may be a continuous tubing, a cutting tool 132 may be disposed within automatic diaper pail 100 to assist a user in cutting a used portion of the tubing and permit the user to remove and dispose of the severed portion of the flexible tubing.

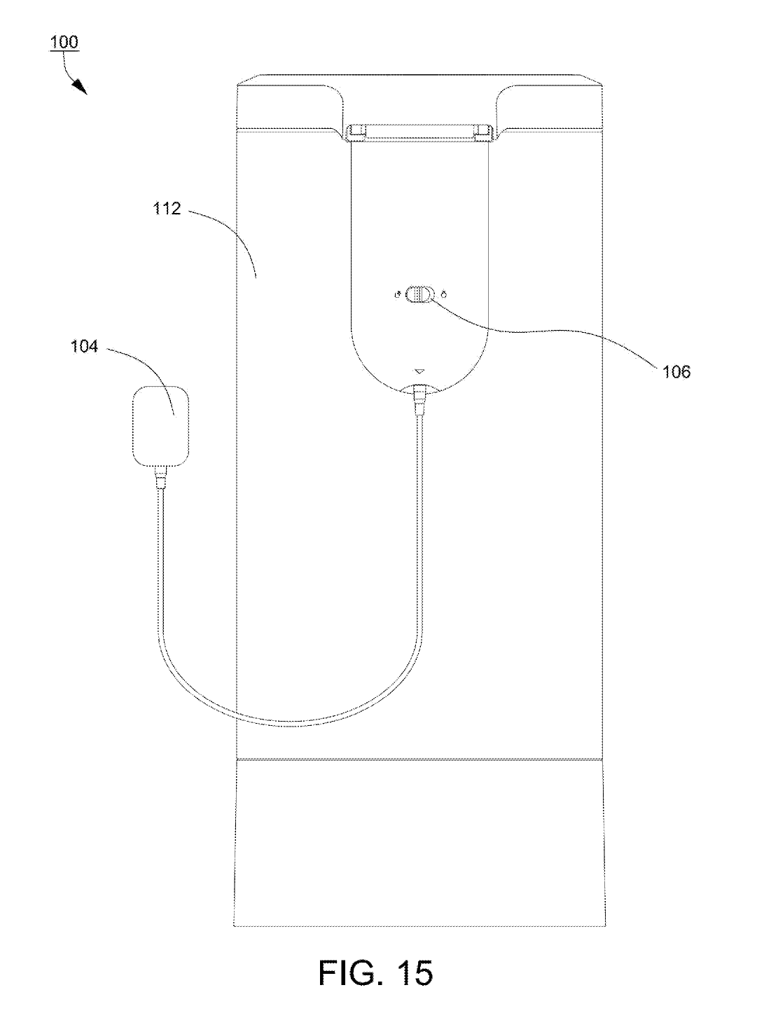

FIG. 15 is a rear view of the automatic diaper pail 100 showing the power connection or power supply 104. In some embodiments, power is supplied through a USB. For example, FIGS. 3 and 10 illustrate power supply 104 in communication with USB PCB 102. USB PCB 102 can communicate with other PCBs disposed within the automatic diaper pail 100. USB PCB 102 can be configured to operate various aspects of the present technology. For example, PCB PCB 102 can be used to effectuate motion of the rotation mechanism 190. In some embodiments, the various PCBs can communicate with each other to perform functions together. For example, when sensor 210 detects touchless motion, sensor PCB 212 can communicate with lid motor PCB 238 to actuate lid motor 232 and open top lid 220. The lid motor PCB 238 may also assist regulating the electrical current in the motor that drives the lid. As another example, sensor 214 (e.g., disposed inside lid assembly 200) may determine that top lid 220 is opening and communicate with a PCB associated with rotation mechanism 190 (e.g., control PCB 152) to cause rotation mechanism 190 to turn and untwist sleeve 160 into an open position. As another example, sensor 214 (e.g., disposed inside lid assembly 200) may determine that top lid 220 is closing and communicate with rotation mechanism 190 (e.g., via control PCB 152) to cause rotation mechanism 190 to turn and twist sleeve 160 into a closed or cinched position. One of ordinary skill in the art would understand that the foregoing discussion is not limited to implementation via PCB and that the present disclosure teaches the use of other components and controllers to communicate with and coordinate functions of the various structures. For example, central processing units, graphics processing units, application-specific integrated circuits, and other components can be used to communicate with and control functions of the various structures herein.

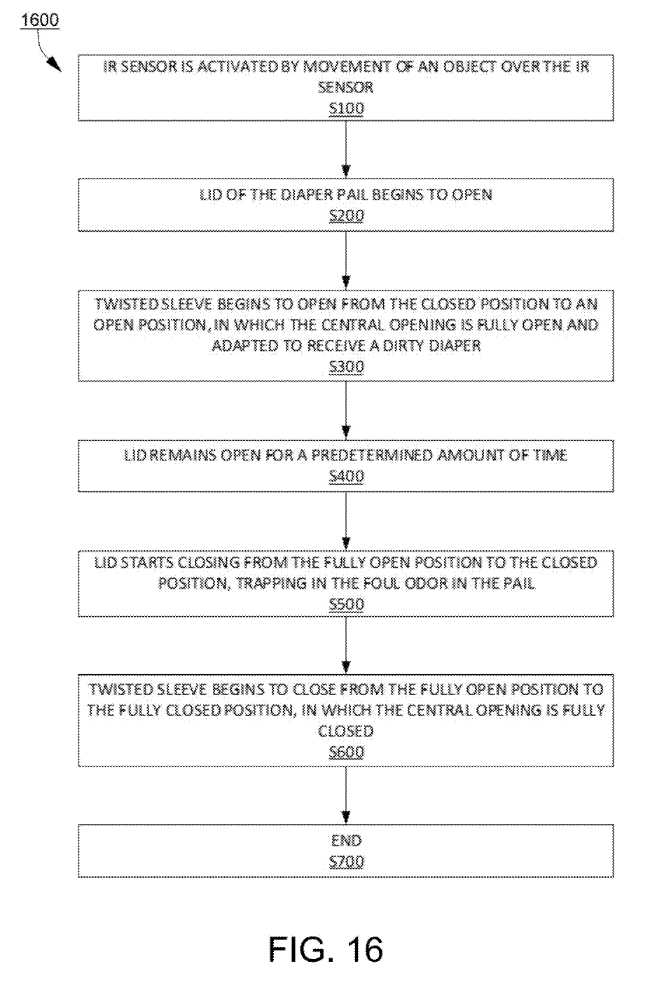

FIG. 16 represents an exemplary method or routine 1600 of opening and closing a diaper pail. According to one exemplary embodiment, in a first step S100 at time 0.0 seconds, an IR sensor is activated by the movement of an object over the IR sensor, such as a hand motion. At the beginning of step S100, the sleeve within the diaper pail is in a closed twisted position. A time delay may be programmed in upon activation before step S200 begins. The routine then proceeds to step S200.

Step S200 may begin at 0.5 seconds in which a lid of the diaper pail begins to open. An exemplary opening speed for the lid may take approximately 1.5 seconds in duration to open from the closed position to an open position. The routine then proceeds to step S300.

In step S300, the twisted sleeve begins to open from the closed position to an open position in which the central opening is fully open and adapted to receive a dirty diaper. The opening of the twisted sleeve can occur at various times. The opening may occur as soon as the lid begins to open, or at a delayed time after the lid begins to open. If delayed, the opening movement of the sleeve may occur a predetermined period of time after the lid has completely opened up. The benefit of the delay is that the lid is completely open and out of the way before the sleeve opens up to receive the dirty diaper without delay from the lid opening thereby to prevent the escape of any foul odor that may be in the diaper pail below the twist in the sleeve. This is also beneficial in that the twisted sleeve would not have to be open as long, just long enough to receive the dirty diaper and then can be timed to close back up immediately. The opening movement of the twisted sleeve may be timed to open completely from a closed position to a fully open position in approximately 3.5 seconds. The routine then proceeds to step S400.

In step S400, the lid will remain open for a predetermined period of time, such as for example 2.5 seconds. During that time, the user can place the dirty diaper into the central opening within the untwisted sleeve so that the dirty diaper may fall into the diaper container. If the IR sensor senses the users hand in the vicinity of the sensor, the lid may remain open until hand is moved from that proximity so as not to start closing on the users contemporaneous operation of disposing the diaper into the central opening should the user take longer than the predetermined open period of time. The routine will then proceed to step S500.

In step S500, the lid may be timed to start closing from the fully open position to the closed position trapping in the foul odor in the pail. The routine will then proceed to step S600.

In step S600, the twisted sleeve will begin to close from the fully open position to the fully closed position in which the central opening is fully closed. The twisting close of the open sleeve can occur at various times. The closing may occur as soon as the lid begins to close, or at a delayed time after the lid begins to close. If delayed, the closing movement of the sleeve may occur a predetermined period of time after the lid has begun to close or at a time after the lid has completely closed. The closing movement of the sleeve twisting close may be timed to close completely from a fully open position to a fully closed position in approximately 3.5 seconds. The routine will then proceed to step S700.

In step S700, the routine is complete and terminates. The entire routine may occur in approximately 10 seconds. However, it is to be understood that the routine may vary depending on desired programming or user interaction with the diaper pail.

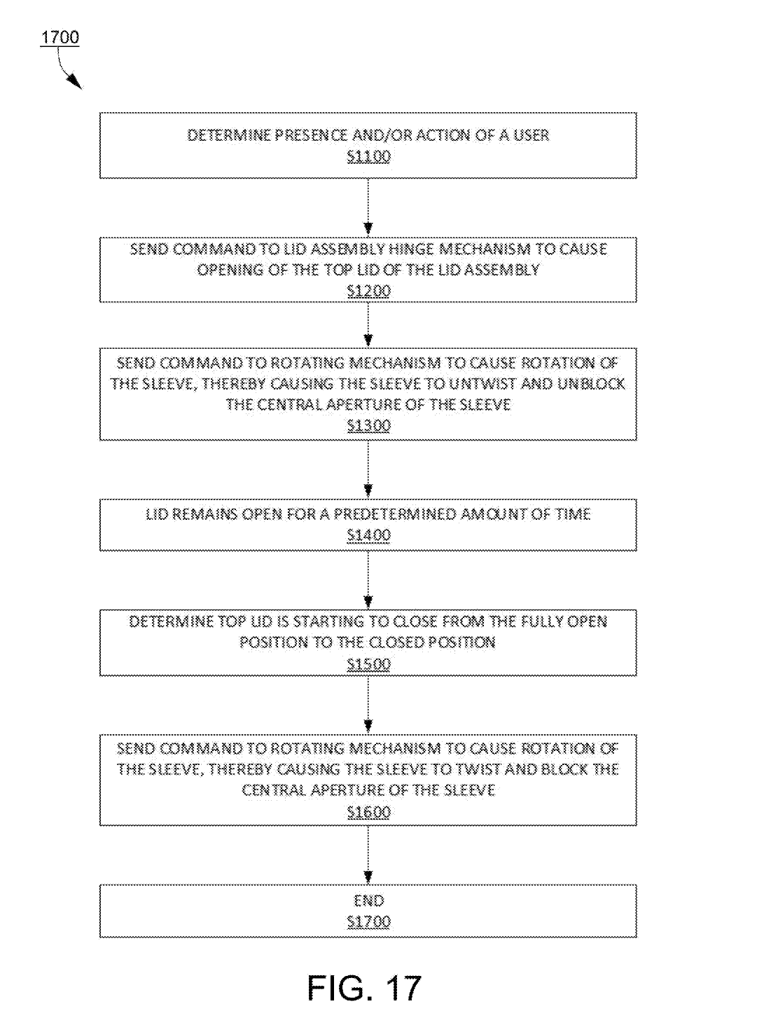

FIG. 17 illustrates an exemplary method or routine for opening and/or closing an automatic diaper pail, such as automatic diaper pail 100. One of ordinary skill in the art would understand that the following discussion need not be sequential and that some steps may happen in different sequences, at different times, concurrently, and other combinations thereof.

Method 1700 begins at step S1100, in which automatic diaper pail 100 determines a presence and/or action of a user. For example, automatic diaper pail 100 may detect motion of a user, such as a hand wave over a motion sensor of automatic diaper pail 100.

At step S1200, automatic diaper pail 100 sends a command to lid assembly hinge mechanism to cause opening of the top lid of the lid assembly in response to determining the presence and/or action of the user. For example, automatic diaper pail 100 may send a command to a lid motor controller or PCB controlling the lid assembly hinge mechanism. The lid motor controller or PCB can receive the command and open the top lid of the lid assembly in response to the command.

At step S1300, automatic diaper pail 100 sends a command to the rotating mechanism to cause rotation of the sleeve, thereby causing the sleeve to untwist and unblock the central aperture of the sleeve. For example, automatic diaper pail 100 may send a command to a rotating mechanism controller or control PCB controlling the rotating mechanism. The rotating mechanism control or control PCB can receive the command and untwist the sleeve in response to the command.

At step S1400, the lid may remain open for a predetermined amount of time to allow a user to place objects through the central aperture and into the automatic diaper pail 100.

At step S1500, automatic diaper pail 100 determines that the top lid is starting to close from the fully open position to the closed position. For example, a sensor may be disposed in the automatic diaper pail 100 to determine that the top lid is moving. In some embodiments, a hall sensor may be disposed within the automatic diaper pail to determine movement of at least one component of the lid assembly.

At step S1600, automatic diaper pail 100 sends a command to the rotating mechanism to cause rotation of the sleeve, thereby causing the sleeve to twist and block the central aperture of the sleeve in response to determining that the top lid is closing. For example, automatic diaper pail 100 may send a command to a rotating mechanism controller or control PCB controlling the rotating mechanism. The rotating mechanism control or control PCB can receive the command and rotate the sleeve closed in response to the command. The method ends at S1700 and can be repeated as desired thereafter.

The illustrations and examples provided herein are for explanatory purposes and are not intended to limit the scope of the appended claims. It will be recognized by those skilled in the art that changes, or modifications may be made to the above-described embodiments without departing from the broad inventive concepts of the invention. It is understood therefore that the invention is not limited to the particular embodiments which are described but is intended to cover all modifications and changes within the scope and spirit of the subject disclosure.

The foregoing disclosure of the exemplary embodiments of the present subject disclosure has been presented for purposes of illustration and description. It is not intended to be exhaustive or to limit the subject disclosure to the precise forms disclosed. Many variations and modifications of the embodiments described herein will be apparent to one of ordinary skill in the art in light of the above disclosure. The scope of the subject disclosure is to be defined only by the claims appended hereto, and by their equivalents.

Further, in describing representative embodiments of the present subject disclosure, the specification may have presented the method and/or process of the present subject disclosure as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present subject disclosure should not be limited to the performance of their steps in the order written, and one skilled in the art can readily appreciate that the sequences may be varied and still remain within the spirit and scope of the present subject disclosure.

What is claimed:

1. An automatic diaper pail, comprising:
a container body;
a base attached to a lower end of the body;
a lid assembly pivotably attached to the container body via a hinge, wherein the lid assembly includes a lid and a sensor adapted to detect a presence or action of a user; and
a sleeve rotating mechanism disposed within the container body, the sleeve rotating mechanism including a sleeve and a motor adapted to rotate the sleeve, wherein the sleeve is adapted to transition between an open position and a cinched closed position.

2. The diaper pail of claim 1, wherein the lid assembly includes a lid motor operable to transition the lid between an open configuration and a closed configuration.

3. The diaper pail of claim 1, further comprising:
a controller configured to communicate with the sensor, the lid assembly, and the sleeve rotating mechanism, wherein the controller is configured to:
determine that the sensor has detected a presence or action of the user, and
cause transitioning of the lid to an open configuration and rotation of the sleeve to the open position.

4. The diaper pail of claim 1, further comprising:
a controller configured to communicate with the sensor, the lid assembly, and the sleeve rotating mechanism, wherein the controller is configured to:
determine that the lid is moving to an open configuration, and
cause rotation of the sleeve to the open position.

5. The diaper pail of claim 1, wherein the lid assembly is in communication with the sleeve rotating mechanism to coordinate substantially simultaneous opening of the lid and rotation of the sleeve to the open position.

6. The diaper pail of claim 1, further comprising:
a bag support structure positioned within the housing, the bag support structure having an opening adapted to receive at least one flexible bag assemblies.

7. The diaper pail of claim 6, wherein the bag support structure includes a first stationary support member with a first support surface onto which a first bag assembly is secured and a second stationary support member having a second support surface that extends horizontally below the first support surface that is adapted to receive a cassette of a second bag assembly.

8. The diaper pail of claim 1, wherein the sleeve rotating mechanism includes a top sleeve retainer and a lower sleeve retainer, and wherein the top sleeve retainer is attached to a circular gear of the sleeve rotating mechanism, and wherein the lower sleeve retainer is stationary.

9. The diaper pail of claim 8, wherein the motor rotates top sleeve retainer via the circular gear and causes the sleeve to twist or untwist as the top sleeve retainer rotates relative to the lower sleeve retainer.

10. A diaper pail, comprising:
a container body;
a base attached to a lower end of the body;
a lid assembly pivotably attached to the container body via a hinge, wherein the lid assembly includes a top lid, a lower lid, and a sensor adapted to detect a presence or action of a user; and
a sleeve rotating mechanism disposed within the container body, the sleeve rotating mechanism including a sleeve and a motor adapted to rotate an upper end of the sleeve relative to a lower end of the sleeve, and wherein the sleeve is adapted to transition between an open position and a cinched closed position.

11. The diaper pail of claim 10, wherein the lid assembly includes a lid motor operable to transition the top lid between an open configuration and a closed configuration.

12. The diaper pail of claim 10, further comprising:
a controller configured to communicate with the sensor, the lid assembly, and the sleeve rotating mechanism, wherein the controller is configured to:
determine that the sensor has detected a presence or action of the user, and
cause transitioning of the top lid to an open configuration and rotation of the sleeve to the open position.

13. The diaper pail of claim 10, further comprising:
a controller configured to communicate with the sensor, the lid assembly, and the sleeve rotating mechanism, wherein the controller is configured to:
determine that the top lid is moving to an open configuration, and
cause rotation of the sleeve to the open position.

14. The diaper pail of claim 10, wherein the lid assembly is in communication with the sleeve rotating mechanism to coordinate substantially simultaneous opening of the top lid and rotation of the sleeve to the open position.

15. The diaper pail of claim 10, further comprising:
a bag support structure positioned within the housing, the bag support structure having an opening adapted to receive at least one flexible bag assemblies.

16. The diaper pail of claim 15, wherein the bag support structure includes a first stationary support member with a first support surface onto which a first bag assembly is secured and a second stationary support member having a second support surface that extends horizontally below the first support surface that is adapted to receive a cassette of a second bag assembly.

17. The diaper pail of claim 10, wherein the sleeve rotating mechanism includes a top sleeve retainer and a lower sleeve retainer, and wherein the top sleeve retainer is attached to a circular gear of the sleeve rotating mechanism, and wherein the lower sleeve retainer is stationary.

18. The diaper pail of claim 17, wherein the motor rotates top sleeve retainer via the circular gear and causes the sleeve to twist or untwist as the top sleeve retainer rotates relative to the lower sleeve retainer.

1919 A method for operating an automatic diaper pail, the method comprising:
determining, by a controller, a presence and/or an action of a user;
sending, by the controller, a command to a lid assembly hinge mechanism of the automatic diaper pail to cause opening of a top lid of a lid assembly of the automatic diaper pail; and
sending, by the controller, a command to a rotating mechanism of the automatic diaper pail to cause rotation of a sleeve, thereby causing the sleeve to untwist and unblock a central aperture of the sleeve.

20. The method of claim 19, further comprising:
determining, by the controller, that the top lid is starting to close from a fully open position; and
sending, by the controller, a closing command to the rotating mechanism to cause rotation of the sleeve, thereby causing the sleeve to twist and block the central aperture of the sleeve.
